(19) United States
(12) Patent Application Publication
(10) Pub. No.: US 2022/0036130 A1
(43) Pub. Date: Feb. 3, 2022

(54) METHOD OF GENERATING TRAINING DATA, TRAINING DATA GENERATING APPARATUS, AND IMAGE PROCESSING APPARATUS

(71) Applicant: CASIO COMPUTER CO., LTD., Tokyo (JP)

(72) Inventor: Naotomo Miyamoto, Tokyo (JP)

(21) Appl. No.: 17/388,603

(22) Filed: Jul. 29, 2021

(30) Foreign Application Priority Data
Jul. 30, 2020 (JP) 2020-129126

(51) Int. Cl. G06K 9/62; G06T 7/20; G06T 7/70; G06N 20/00; B66F 9/06; B66F 9/075

(52) U.S. Cl. CPC G06K 9/6256; G06T 7/20; G06T 7/70; G06N 20/00; H04B 10/116; B66F 9/0755; G06T 2207/10016; G06T 2207/20081; G06T 2207/30204; B66F 9/063

(57) ABSTRACT

An objective is to efficiently store images to be used as training data. A server determines an image area (first image area) including an image of a marker or the like, in a captured image corresponding to image data acquired by image capturing by a camera, for example. The server then determines an image area (second image area) of a moving body (for example, forklift) equipped with the marker or the like. The server generates and stores training data corresponding to the second image area. The training data will be used for machine learning later.

### CROSS-REFERENCE TO RELATED APPLICATION

This application claims the benefit of Japanese Patent Application No. 2020-129126 filed on Jul. 30, 2020, the entire disclosure of which is incorporated by reference herein.

### FIELD

This application relates to a method of generating training data, a training data generating apparatus, and an image processing apparatus.

### BACKGROUND

In recent years, development of techniques of machine learning has accompanied generation of annotation (training data on image) for use in machine learning. A typical example of the process of designating an image of a specific portion of a subject to be used as training data is an annotation process for medical images by manual operations (for example, Unexamined Japanese Patent Application Publication No. 2020-35095).

### SUMMARY

Unfortunately, the selection of images necessary for generation of training data in the above-mentioned process largely depends on manual operations of an operator and requires a lot of manpower.

A method of generating training data, which is executed by a computer, according to an aspect of the disclosure includes: determining a second image area, which includes a first image area for acquiring identification information on a moving body, in at least one captured image; and generating training data for machine learning, which corresponds to the determined second image area.

An advantageous effect of the aspect of the disclosure is efficient storage of images to be used as training data.

### BRIEF DESCRIPTION OF THE DRAWINGS

A more complete understanding of this application can be obtained when the following detailed description is considered in conjunction with the following drawings, in which:

FIG. 1 illustrates an exemplary configuration of a visible light communication system according to an embodiment of the disclosure;

FIG. 2 illustrates an exemplary configuration of a forklift according to the embodiment;

FIG. 3 illustrates exemplary configurations of a camera, a server, and a database according to the embodiment;

FIG. 4 illustrates an example of captured-image data according to the embodiment;

FIG. 5A illustrates an example including an image area of a marker and an image area of the forklift according to the embodiment;

FIG. 5B illustrates an example including a smaller image area of the marker than that in FIG. 5A;

FIG. 6 illustrates an example of area data according to the embodiment;

FIG. 7 illustrates an example of training data according to the embodiment;

FIG. 8A illustrates an example of an image area of the forklift according to the embodiment;

FIG. 8B illustrates an example of an image area of the forklift generated by changing the color of the image area of the marker in FIG. 8A;

FIG. 9 is a flowchart illustrating an exemplary training data generating process according to the embodiment;

FIG. 10 is a flowchart illustrating an exemplary process of changing the color of an image area of the marker according to the embodiment;

FIG. 11 is a flowchart illustrating an exemplary training data generating process according to another embodiment of the disclosure;

FIG. 12 is a flowchart illustrating an exemplary alert notification process according to the embodiment;

FIG. 13A illustrates another example including an image area of the forklift;

FIG. 13B illustrates an example including a smaller image area of the forklift than that in FIG. 13A;

FIG. 14A illustrates another example including an image area of the forklift; and

FIG. 14B illustrates an example including an image area of the marker located at an upper position than that in FIG. 14A.

### DETAILED DESCRIPTION

A visible light communication system according to embodiments of the disclosure will now be described with reference to the accompanying drawings.

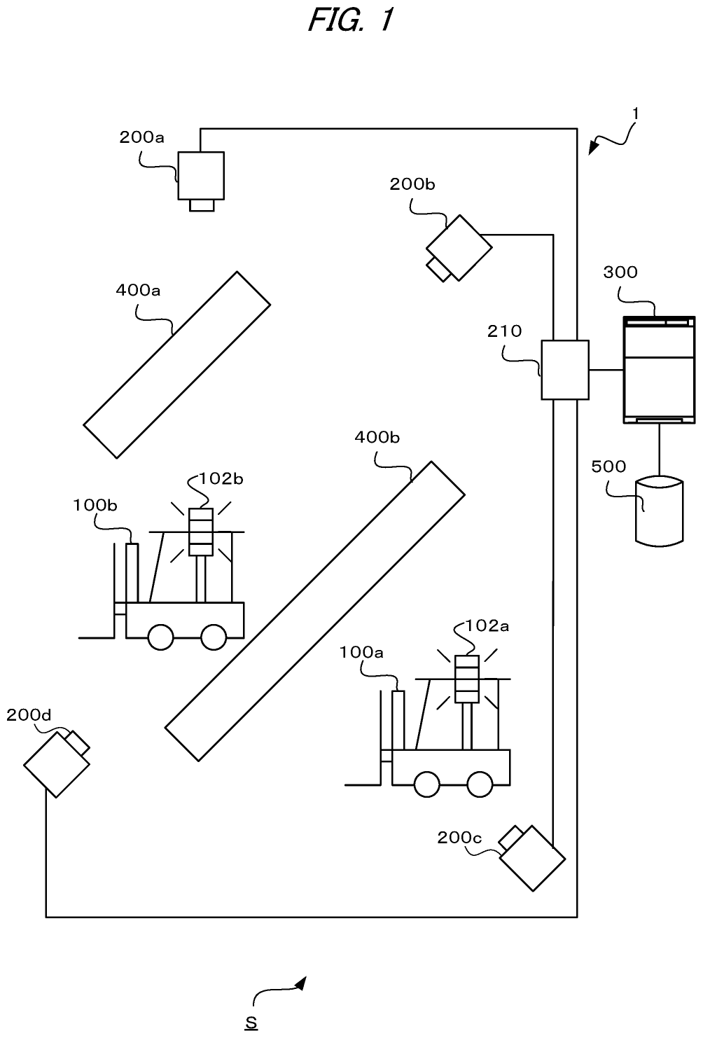

FIG. 1 illustrates an exemplary configuration of a visible light communication system. As illustrated in FIG. 1, the visible light communication system 1 is applied to a space S. The space S is equipped with shelfs 400a and 400b, and encompasses forklifts 100a and 100b (hereinafter referred to as “forklifts 100” or “moving body” as appropriate, unless the forklifts 100a and 100b should be discriminated), cameras 200a, 200b, 200c, and 200d (hereinafter referred to as “cameras 200” as appropriate, unless the cameras 200a, 200b, 200c, and 200d should be discriminated), a hub 210, a server 300, and a database 500.

The forklift 100a includes a marker (light-emitting object) 102a, which is a light emitting diode (LED), and the forklift 100b includes a marker 102b (the markers 102a and 102b are hereinafter referred to as “markers 102” as appropriate, unless the markers 102a and 102b should be discriminated). The server 300 is connected to the cameras 200 via the hub 210. The server 300 is also connected to the database 500 via a local area network (LAN), which is not shown.

In the embodiment, each of the markers 102 mounted on the respective forklifts 100 has a luminescent color varying with time in accordance with communication data, which contains identification information on the forklift 100, that is, information to be transmitted, and thereby transmits the information through visible light communication. The identification information in the embodiment corresponds to a classification ID indicating that the forklift 100 is classified as a forklift. The identification information may also contain a vehicle number or other data for uniquely identifying the forklift 100 in addition to the classification ID.

The cameras 200 capture images of the entire space S. On the basis of the images of the entire space S captured by the cameras 200, the server 300 acquires the positions (two-dimensional positions) of the marker 102 in the images and the position (three-dimensional position) of the marker 102 in the space S through visible light communication. The server 300 also decodes the time variation in the luminescent color of the marker 102 and thereby acquires the communication data from the forklift 100. The server 300 also generates training data, which is used for identifying an image area of the forklift 100 in the image during machine learning, in the embodiment.

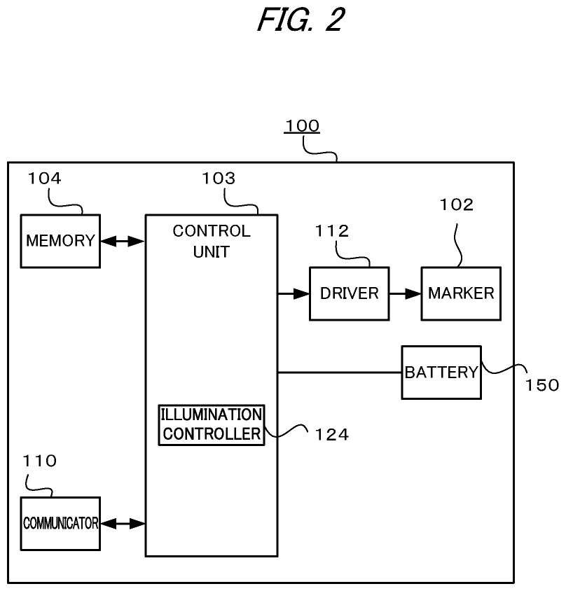

FIG. 2 illustrates an exemplary configuration of the forklift 100. As illustrated in FIG. 2, the forklift 100 includes the marker 102, a control unit 103, a memory 104, a communicator 110, a driver 112, and a battery 150.

The control unit 103 includes, for example, a central processing unit (CPU). The control unit 103 executes software processes in accordance with programs stored in the memory 104, and thereby controls various functions of the forklift 100.

The memory 104 includes, for example, a random access memory (RAM) and a read only memory (ROM). The memory 104 stores various information, such as programs, to be used in controls and other operations in the forklift 100.

The communicator 110 includes, for example, a LAN card. The communicator 110 executes wireless communication with the server 300 or other apparatuses. The battery 150 supplies the individual components with electric power necessary for operations of the forklift 100.

The control unit 103 reads the identification information on the forklift 100 stored in the memory 104.

The control unit 103 includes an illumination controller 124. The illumination controller 124 determines an illumination pattern for varying the luminescent color with time in accordance with the identification information, which is communication data.

The illumination controller 124 then outputs information on the illumination pattern to the driver 112. On the basis of the information on the illumination pattern from the illumination controller 124, the driver 112 generates a driving signal for causing a time variation of the hue of the light to be emitted from the marker 102. The marker 102 emits light of which the hue varies with time, in accordance with the driving signal output from the driver 112. For example, the luminescent color is any of read (R), green (G), and blue (B), which are the three primary colors of light in the wavelength band used for color shift keying modulation in visible light communication.

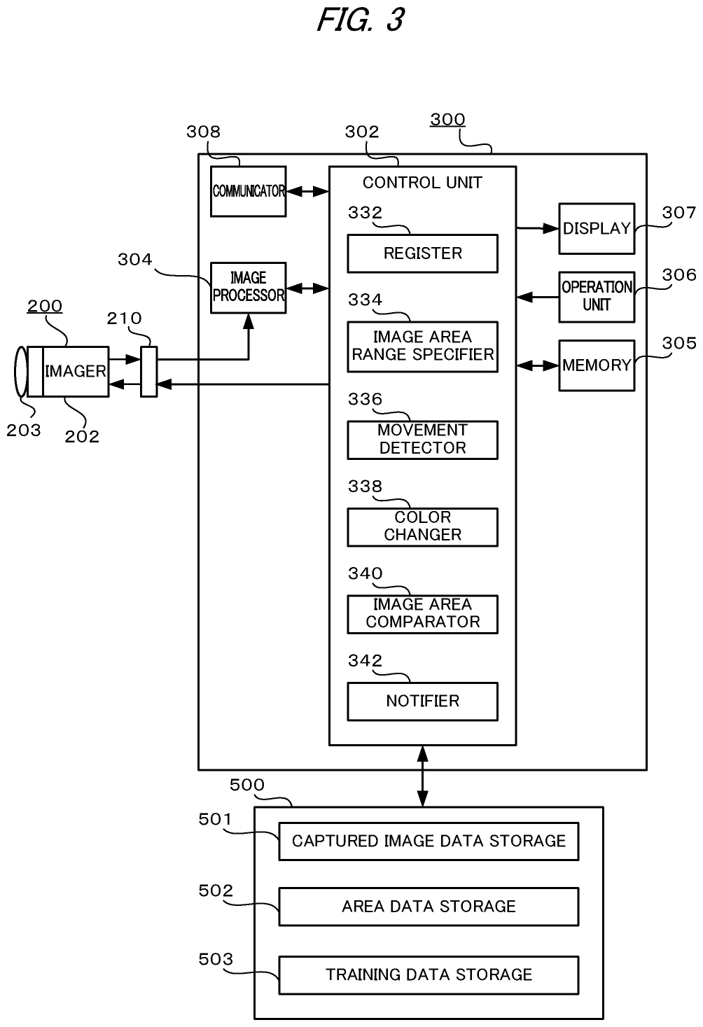

FIG. 3 illustrates exemplary configurations of the camera 200, the server 300, and the database 500. As illustrated in FIG. 3, the camera 200 is connected to the server 300 via the hub 210 and connected to the database 500 via a LAN. The camera 200 includes an imager 202 and a lens 203. The server 300 includes a control unit 302, an image processor 304, a memory 305, an operation unit 306, a display 307, and a communicator 308. The database 500 includes a captured-image data storage 501, an area data storage 502, and a training data storage 503.

The lens 203 in the camera 200 includes a zoom lens, for example. The lens 203 is shifted in response to a zooming control operation from the operation unit 306 in the server 300 and a focusing control by the control unit 302. The shift of the lens 203 controls the angle of view of the imager 202 and optical images captured by the imager 202.

The imager 202 is equipped with multiple light receiving elements arranged in a regular two dimensional array on the light receiving surface including an imaging surface. The light receiving elements are each composed of an imaging device, such as a charge coupled device (CCD) or a complementary metal oxide semiconductor (CMOS). The imager 202 performs capturing (light receiving) of optical images incident through the lens 203 in a predetermined range of angle of view, in accordance with a control signal from the control unit 302 in the server 300. The imager 202 then converts image signals within the angle of view into digital data to generate frames. The imager 202 captures an image and generates a frame sequentially in time, and outputs digital data on the successive frames to the image processor 304.

On the basis of the control signal from the control unit 302, the image processor 304 performs distortion correction, color adjustment, and noise removal to digital data on the frames output from the imager 202, and outputs the processed data to the control unit 302.

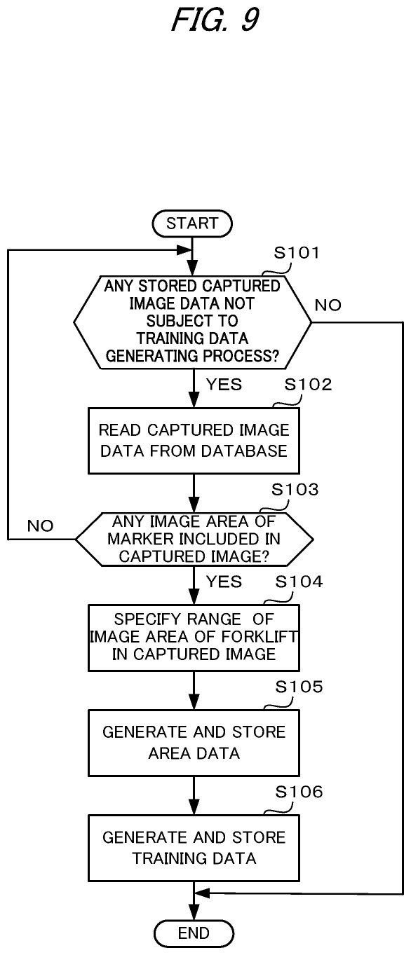

The control unit 302 includes at least one processor, such as CPU. The control unit 302 executes software processes in accordance with programs stored in the memory 305, and thereby controls various functions of the server 300, such as the functions of executing the processes illustrated in FIGS. 9 to 12, which will be explained below.

The memory 305 includes, for example, a RAM and a ROM. The memory 305 stores various information, such as programs, to be used in controls and other operations in the server 300.

The operation unit 306 includes a numeric keypad and function keys and serves as an interface for input of an operation of a user. The display 307 includes, for example, a liquid crystal display (LCD), a plasma display panel (PDP), or an electroluminescence (EL) display. The display 307 displays an image in accordance with the image signal received from the control unit 302. The communicator 308 includes, for example, a LAN card. The communicator 308 communicates with external communication apparatuses.

The control unit 302 includes a register 332, an image area range specifier 334, a movement detector 336, a color changer 338, an image area comparator 340, and a notifier 342.

The register 332 adds an image ID, which is identification information on the image data, to each piece of digital data (image data) on the frames output from the imager 202 in the camera 200, and thereby generates captured-image data.

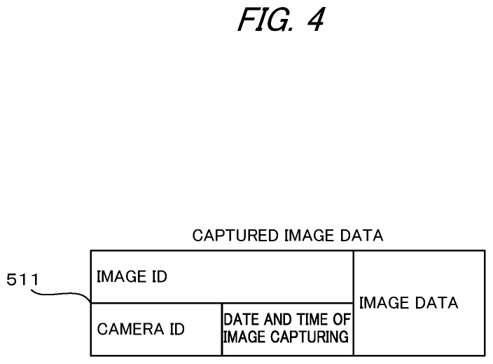

FIG. 4 illustrates an example of captured-image data. The image ID contains a camera ID and a date and time of image capturing by the camera 200. The camera ID is identification information on the camera 200 that has output the corresponding image data, that is, the camera 200 that has captured the corresponding image.

The image ID, the camera ID, and the date and time of image capturing are stored in the form of profile data, together with the image data in the captured-image data, but may be set as independent data associated with the image data.

Referring back to FIG. 3, the register 332 causes the generated captured-image data to be stored into the captured-image data storage 501 in the database 500.

The image area range specifier 334 acquires luminance values of the individual pixels constituting the frame for each piece of digital data on the frames output from the imager 202. The image area range specifier 334 then deems the positions of the pixels having at least a predetermined luminance value in the frame to correspond to the position of the marker 102. The image area range specifier 334 then decodes the variation in the luminescent color at the position of the marker 102 in the frame, and thereby acquires the classification ID contained in the communication data transmitted from the marker 102. The following steps are executed for each classification ID.

The image area range specifier 334 reads captured-image data from the captured-image data storage 501, and then determines whether any image area of the marker 102 is included in the captured image corresponding to the image data contained in the captured-image data. Specifically, the image area range specifier 334 determines that an image area of the marker 102 is included if any pixel having at least a predetermined luminance value exists in the captured image.

If any image area of the marker 102 is included, the image area range specifier 334 specifies the range of the image area where an image of the forklift 100 is expected to exist, in the captured image corresponding to the image data contained in the captured-image data. Specifically, the image area range specifier 334 specifies the range of the image area of the forklift 100, which is preliminarily determined such that the position of the marker 102 is located at the center of the captured image, the image of the marker 102 is located at a slightly upper position in the vertical direction and is located at the center in the horizontal direction, the size of the range increases in proportion to the size of the image area of the marker 102, and the range substantially encompasses the image of the forklift 100.

In this step, the image area range specifier 334 determines the size of the image area of the marker 102. The image area range specifier 334 specifies the range of the image area of the forklift 100 such that the size of the image area of the forklift 100 in the captured image increases with the size of the image area of the marker 102. It should be noted that this specification of the range of the image area of the forklift 100 does not involve detection or image recognition for the image of the forklift 100 from the captured image. That is, the image area range specifier 334 estimates the position and range of the image of the forklift 100 including the marker 102 in the captured image on the basis of the position and size of the marker 102 in the captured image, and specifies the range of the image area of the forklift 100 on the basis of the estimation result.

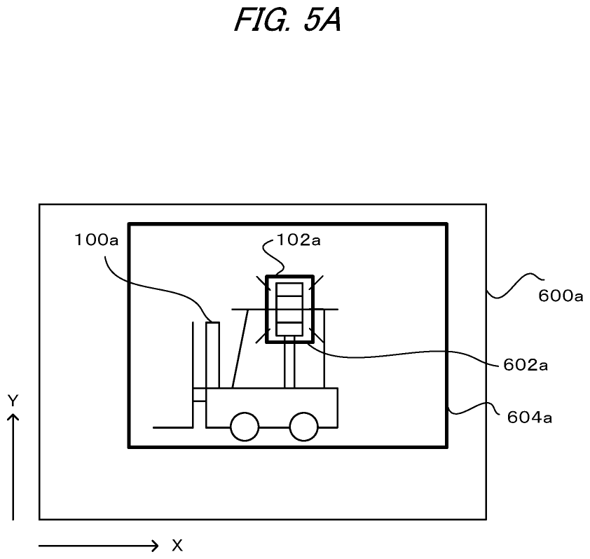

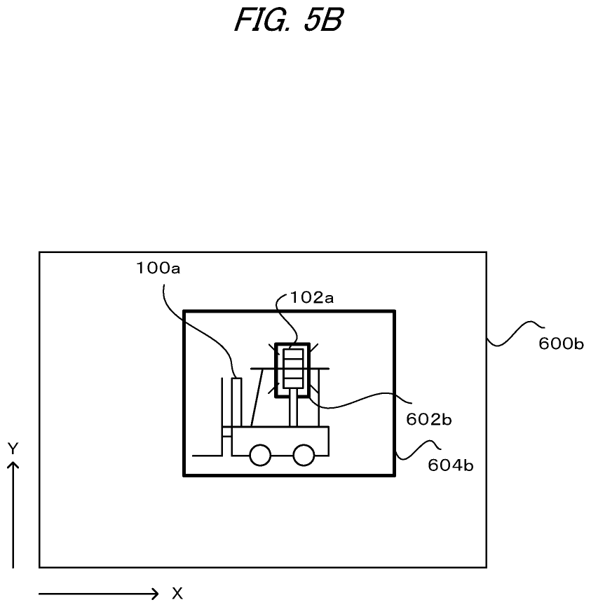

FIGS. 5A and 5B each illustrate an example including an image area of the marker 102 and an image area of the forklift 100. The comparison between a captured image 600a illustrated in FIG. 5A and a captured image 600b illustrated in FIG. 5B reveals that an image area 602a (first image area) of the marker 102a in FIG. 5A is larger than an image area 602b (first image area) of the marker 102a in FIG. 5B. Accordingly, an image area 604a (second image area) of the forklift 100a in FIG. 5A is larger than an image area 604b (second image area) of the forklift 100a in FIG. 5B. The identification information of the moving body can be acquired from the first image area. The first image area is included in the second image area. In one embodiment of the invention, the processor (control unit 302) determines the second image area from the captured image.

The image area range specifier 334 thus controls the size of the image area to be specified so as to vary the size of the image area in proportion to the size of the image of the marker 102, which is identification information. That is, the processor (control unit 302) determines a size of the second image area on basis of a size of the first image area.

Referring back to FIG. 3, after specifying the range of the image area of the forklift 100, the image area range specifier 334 generates area data for specifying the image area of the forklift 100.

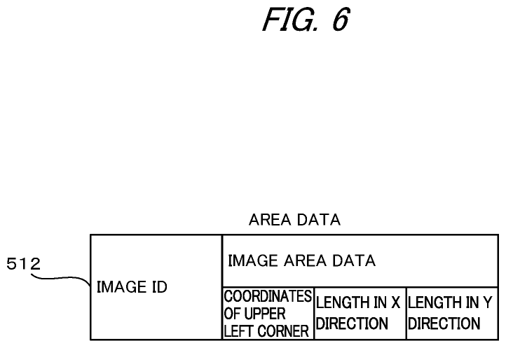

FIG. 6 illustrates an example of area data. Area data 512 illustrated in FIG. 6 contains the image ID of the captured image including the specified image area of the forklift 100, and image area data for specifying the image area of the forklift 100. The image area data indicates the coordinates of the upper left corner of the image area of the forklift 100, the length of the image area in the horizontal X direction, and the length of the image area in the vertical Y direction in the captured image. It should be noted that FIG. 6 illustrates exemplary image area data on the image area of the forklift 100 having a rectangular shape. The image area data may have a different format depending on the shape of the image area of the forklift 100.

Referring back to FIG. 3, the register 332 causes the area data generated at the image area range specifier 334 to be stored into the area data storage 502 in the database 500 in association with the captured-image data.

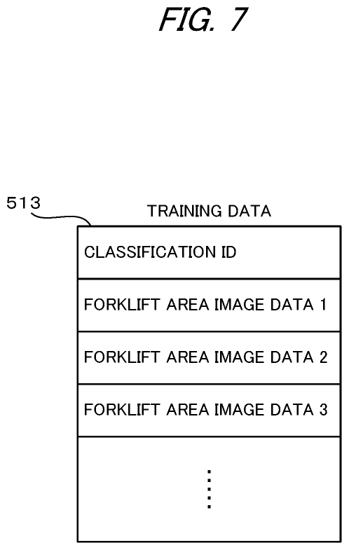

The image area range specifier 334 then generates training data corresponding to the generated area data. FIG. 7 illustrates an example of training data. As illustrated in FIG. 7, training data 513 contains the classification ID and pieces of image data (forklift area image data) associated with the image area of the forklift 100.

In order to generate training data, the image area range specifier 334 obtains the classification ID contained in the communication data acquired in the above-explained process. The image area range specifier 334 then reads captured-image data containing the image ID in the area data associated with the classification ID, from the captured-image data storage 501. The image area range specifier 334 then extracts the range specified by the image area data in the generated area data, from the image data in the read captured-image data, and adds data on the extracted range to the classification ID in the form of forklift area image data.

Referring back to FIG. 3, the register 332 causes the training data generated at the image area range specifier 334 to be stored into the training data storage 503 in the database 500.

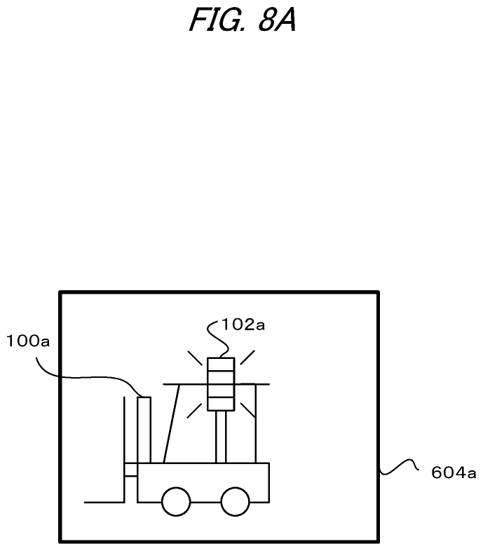

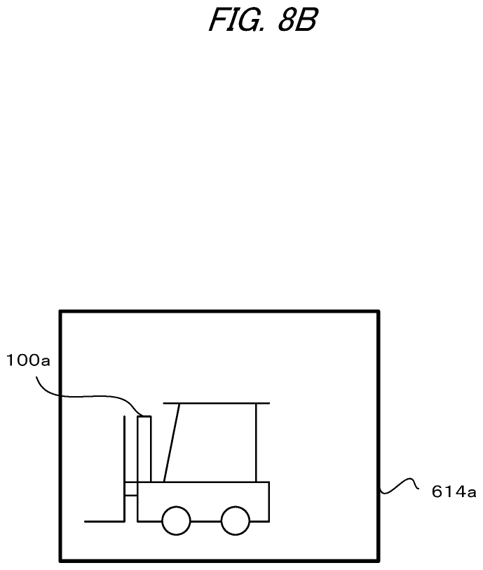

After the generation and storage of the training data, the color changer 338 in the control unit 302 changes the color of the image area of the marker 102 into the color of the circumference of the marker 102, in the image corresponding to the forklift area image data in the training data. The color changer 338 is able to specify the pixels having at least a predetermined luminance value as the image area of the marker 102, as in the above-explained process. The change in the color of the image area of the marker 102, for example, the change in the color of the image area of the marker 102a modifies the image area 604a of the forklift 100 illustrated in FIG. 8A into an image area 614a of the forklift 100 illustrated in FIG. 8B. This process of removing the image of the marker 102 can achieve generation of data on the image area of the forklift 100 serving as versatile training data.

Processes executed in the server 300 will now be explained with reference to the flowcharts.

FIG. 9 is a flowchart illustrating an exemplary training data generating process. The image area range specifier 334 in the control unit 302 of the server 300 determines whether the captured-image data storage 501 stores any captured-image data that has not been subject to the training data generating process (Step S101). If the image area range specifier 334 determines that no captured-image data that has not been subject to the training data generating process is stored, that is, determines that training data has been generated from all the captured-image data stored in the captured-image data storage 501 (Step S101; NO), then the series of steps of the training data generating process is terminated.

In contrast, if determining that any captured-image data that has not been subject to the training data generating process is stored (Step S101; YES), the image area range specifier 334 reads the captured-image data that has not been subject to the training data generating process from the captured-image data storage 501 (Step S102). The image area range specifier 334 then determines whether any image area of the marker 102 is included in the captured image corresponding to the image data contained in the read captured-image data (Step S103). If determining that no image area of the marker 102 is included in the captured image (Step S103; NO), the image area range specifier 334 concludes that the captured-image data does not include an image area to be used as training data, and Step S101 and the following steps are repeated.

In contrast, if determining that any image area of the marker 102 is included in the captured image (Step S103; YES), the image area range specifier 334 specifies the range of the image area of the forklift 100 to be used as training data, in the captured image (Step S104). The image area range specifier 334 then generates area data for specifying the image area of the forklift 100 in the captured image. The register 332 causes the area data, which is extracted and generated from the captured image at the image area range specifier 334, to be stored into the area data storage 502 in the database 500 (Step S105).

The image area range specifier 334 then generates training data corresponding to the generated area data(second image area data). The register 332 causes the training data generated at the image area range specifier 334 to be stored into the training data storage 503 in the database 500 (Step S106). The captured images are a plurality of images captured sequentially in time, the processor (control unit 302) detects the movement of the first image area in the images, and determines the second image area on basis of the movement of the first image area.

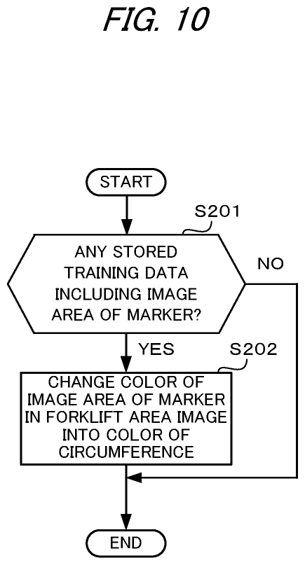

FIG. 10 is a flowchart illustrating an exemplary process of changing the color of an image area of the marker. The color changer 338 in the control unit 302 of the server 300 determines whether any training data including an image area of the marker is stored in the training data storage 503 (Step S201). If the color changer 338 determines that no training data including an image area of the marker is stored in the training data storage 503 (Step S201; NO), then the series of steps is terminated.

In contrast, if determining that any training data including an image area of the marker is stored in the training data storage 503 (Step S201; YES), the color changer 338 changes the color of the image area of the marker 102 in the image corresponding to the forklift area image data in the training data, into the color of the circumference of the marker 102 (Step S202). That is, the processor (control unit 302) changes the color in the first image area in the second image area, and generates the data corresponding to the second image area comprising the first image area in which the color is changed as the training data.

As explained above, the server 300 specifies the image area of the marker 102 in the captured image, which corresponds to the image data acquired through image capturing by the camera 200, and thereby specifies the position and range of the forklift 100 without detection or image recognition from the captured image, in the embodiment. That is, the server 300 estimates the position and range of the image of the forklift 100 including the marker 102 in the captured image on the basis of the position and size of the marker 102 in the captured image, and then specifies the position and range of the forklift 100 on the basis of the estimation result. In addition, the server 300 generates information for specifying the image area of the forklift 100 and causes the information to be stored as training data. This configuration can reduce a variation in generated training data caused by different imaging environments and operators. The configuration can also achieve efficient storage of images to be used as training data without a manual operation of selecting necessary images.

The server 300 specifies the range of the image area of the forklift 100 such that the size of the image area of the forklift 100 increases with the size of the image area of the marker 102. This configuration can achieve exact specification of the range of the image area of the forklift 100 on the basis of the assumption that the size of the image area of the forklift 100 increases with the size of the image area of the marker 102.

The server 300 changes the color of the image area of the marker 102 into the color of the circumference of the marker 102 in the image corresponding to the forklift area image data in the training data. This configuration can achieve generation of versatile training data based on a simulated state of no marker 102, in view of the fact that a forklift 100 includes no marker 102 in general.

The server 300 generates training data containing pieces of image data for each classification ID. This training data facilitates specification of a subject in the unit of classification ID in machine learning.

The following description is directed to another embodiment. In this embodiment, the register 332 in the control unit 302 of the server 300 illustrated in FIG. 3 adds an image ID, which is identification information on the image data, to each piece of digital data (image data) on the frames output from imager 202 in the camera 200 to thereby generate captured-image data, and causes the generated captured-image data to be stored into the captured-image data storage 501 in the database 500, as in the above-described embodiment.

The image area range specifier 334 analyzes pieces of image data corresponding to the captured images from the multiple cameras 200, and thus deems the positions of the pixels having at least a predetermined luminance value in each piece of image data to correspond to the position of the marker 102, as in the above-described embodiment. The image area range specifier 334 then decodes the variation in the luminescent color at the position of the marker 102 in the frame, and thereby acquires the classification ID contained in the communication data transmitted from the marker 102. The following steps are executed for each classification ID.

The image area range specifier 334 then specifies the three-dimensional position of the forklift 100 in the space S, on the basis of the captured-image data corresponding to the digital data (image data) on the frames output from the imagers 202 in at least two cameras 200.

Specifically, the image area range specifier 334 reads the pieces of captured-image data acquired through image capturing by at least two cameras 200 on the identical date and time, from the captured-image data storage 501. The image area range specifier 334 then analyzes the image data in the read captured-image data, and specifies an object having at least a predetermined luminance value and showing the identical illumination pattern as the marker 102.

The image area range specifier 334 then specifies the three-dimensional position of the marker 102 in the space S using information on the position (two-dimensional position) of the marker 102 in each image corresponding to the image data in the read captured-image data, the position of each camera 200, and the range of image capturing of each camera 200, on the basis of the technique disclosed in Unexamined Japanese Patent Application Publication No. 2020-95005, for example.

The movement detector 336 in the control unit 302 then specifies the manner of variation continuous in time in the three-dimensional position of the marker 102 in the space S. On the basis of the specified manner of variation, the movement detector 336 determines whether the behavior of the forklift 100 including the marker 102 involves a rapid deceleration or sudden stop, for example, deviated from the operation in accordance with a predetermined schedule. For example, the movement detector 336 specifies the three-dimensional position of the marker 102 in the space S at predetermined time intervals, and determines that the behavior of the forklift 100 involves a rapid deceleration or sudden stop in the case of a sudden reduction in the variation in the three-dimensional position.

If the behavior of the forklift 100 involves a rapid deceleration or sudden stop, the movement detector 336 specifies the time of occurrence of the rapid deceleration or sudden stop. The time of occurrence of the rapid deceleration or sudden stop can be specified using the date and time of image capturing in the corresponding captured-image data.

The image area range specifier 334 then reads the captured-image data that contains the date and time of image capturing encompassed in a predetermined period including the time of occurrence of the rapid deceleration or sudden stop and also contains the camera ID identical to that of the captured-image data used for the above-explained specification of the three-dimensional position of the marker 102 in the space S, from the captured-image data storage 501. That is, the processor (control unit 302) detects a rapid deceleration or a sudden stop of the moving body and generates the training data on basis of a captured image of the moving body corresponding to a time of occurrence of the rapid deceleration or sudden stop.

The image area range specifier 334 then analyzes the image data in the read captured-image data, and specifies the area having at least a predetermined luminance value and showing the identical illumination pattern as the image area of the marker 102.

If the image area of the marker 102 is included, the image area range specifier 334 specifies the range of the image area of the forklift 100 to be used as training data, in the captured image corresponding to the image data contained in the captured-image data. Specifically, the image area range specifier 334 determines the size of the image area of the marker 102 in the captured image, as in the above-described embodiment. The image area range specifier 334 then specifies the range of the image area of the forklift 100 such that the size of the image area of the forklift 100 increases with the size of the image area of the marker 102, assuming that the image area of the forklift 100 in the captured image expands as the size of the image area of the marker 102 increases.

After specifying the range of the image area of the forklift 100, the image area range specifier 334 generates area data for identifying the image area of the forklift 100 within the predetermined period including the time of occurrence of the rapid deceleration or sudden stop, as in the above-described embodiment. The register 332 causes the area data within the predetermined period including the time of occurrence of the rapid deceleration or sudden stop, which is generated at the image area range specifier 334, to be stored into the area data storage 502 in the database 500.

The image area range specifier 334 then generates training data within the predetermined period including the time of occurrence of the rapid deceleration or sudden stop, as in the above-described embodiment. The register 332 causes the training data within the predetermined period including the time of occurrence of the rapid deceleration or sudden stop, which is generated at the image area range specifier 334, to be stored into the training data storage 503 in the database 500.

After or in parallel to the generation and storage of the training data, an alert notification process in case of occurrence of a rapid deceleration or sudden stop of the forklift 100 is performed.

Specifically, the image area comparator 340 in the control unit 302 acquires and analyzes image data from the cameras 200, and specifies the pixels having at least a predetermined luminance value as the image area of the marker 102. The image area comparator 340 then specifies an image area around the specified image area of the marker 102.

The image area comparator 340 then compares the image of the image area around the specified image area of the marker 102 with the image corresponding to the forklift area image data in the training data within the predetermined period including the time of occurrence of the rapid deceleration or sudden stop, which is stored in the training data storage 503, and then determines whether these images are identical or similar to each other. If the images are identical or similar to each other, the notifier 342 in the control unit 302 executes a notification process, for example, by displaying an alert screen on the display 307. That is, the processor (control unit 302) acquires identification information on a moving body on basis of a captured image, and determines whether a movement of the moving body is a predetermined behavior on basis of the captured image and training data, the training data being generated on basis of a captured image corresponding to a past time of occurrence of a rapid deceleration or sudden stop of the moving body, and provides a notification to the moving body if the movement is determined to be the predetermined behavior.

Processes executed in the server 300 will now be explained with reference to the flowcharts.

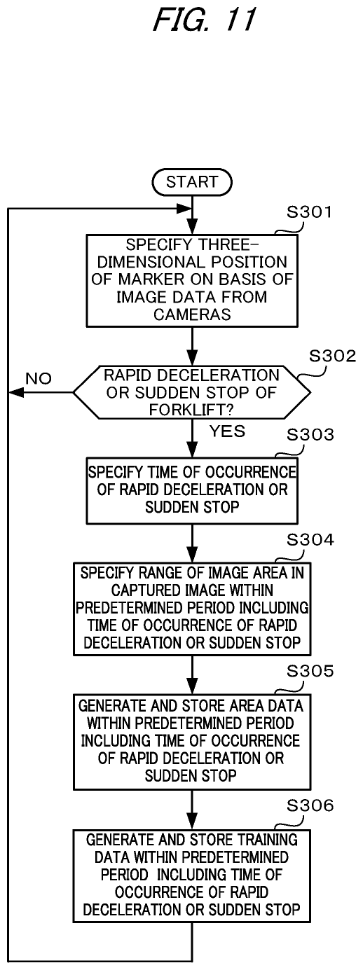

FIG. 11 is a flowchart illustrating an exemplary training data generating process according to the embodiment. The image area range specifier 334 in the control unit 302 of the server 300 specifies the three-dimensional position of the forklift 100 in the space S on the basis of the captured-image data corresponding to the digital data (image data) on the frames output from the imagers 202 in at least two cameras 200 (Step S301).

The movement detector 336 then specifies the manner of variation continuous in time in the three-dimensional position of the marker 102 in the space S, and determines whether the behavior of the forklift 100 involves a rapid deceleration or sudden stop (Step S302). If the movement detector 336 determines that neither a rapid deceleration nor sudden stop occurs (Step S302; NO), the specification of the three-dimensional position of the forklift 100 in the space S (Step S301) and the following step are repeated.

In contrast, if determining that a rapid deceleration or sudden stop of the forklift 100 occurs (Step S302; YES), the movement detector 336 specifies the time of occurrence of the rapid deceleration or sudden stop (Step S303).

The image area range specifier 334 then specifies the range of the image area of the forklift 100 in the captured image within the predetermined period including the time of occurrence of the rapid deceleration or sudden stop (Step S304).

The image area range specifier 334 then generates area data for specifying an area of occurrence of the rapid deceleration or sudden stop in the space S within the predetermined period including the time of occurrence of the rapid deceleration or sudden stop. The register 332 causes the area data within the predetermined period including the time of occurrence of the rapid deceleration or sudden stop to be stored into the area data storage 502 in the database 500 (Step S305).

The image area range specifier 334 then generates training data within the predetermined period including the time of occurrence of the rapid deceleration or sudden stop. The register 332 causes the training data within the predetermined period including the time of occurrence of the rapid deceleration or sudden stop to be stored into the training data storage 503 in the database 500 (Step S306). Then, the specification of the three-dimensional position of the forklift 100 in the space S (Step S301) and the following steps are repeated until the stop of the system.

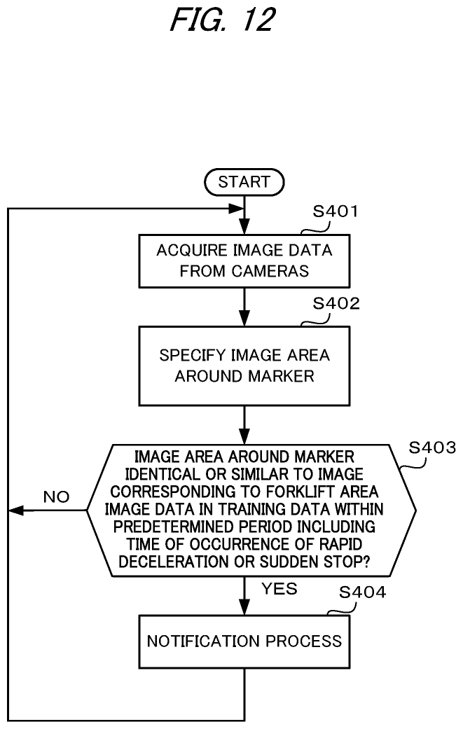

FIG. 12 is a flowchart illustrating an exemplary alert notification process. The image area comparator 340 in the control unit 302 acquires image data from the camera 200 (Step S401).

The image area comparator 340 then specifies the image area around the image area of the marker 102 (Step S402).

The image area comparator 340 then compares the image of the specified image area around the image area of the marker 102 with the image corresponding to the forklift area image data in the training data within the predetermined period including the time of occurrence of the rapid deceleration or sudden stop, which is stored in the training data storage 503, and determines whether these images are identical or similar to each other (Step S403). If the image area comparator 340 determines that the images are not identical or similar to each other (Step S403; NO), the acquisition of the image data (Step S401) and the following steps are repeated.

If the image area comparator 340 determines that the images are identical or similar to each other (Step S403; YES), the notifier 342 executes the notification process (Step S404). Then, the acquisition of the image data (Step S401) and the following steps are repeated until the stop of the system.

As explained above, the server 300 detects a movement of the marker 102 in this embodiment. In the case of occurrence of a rapid deceleration or sudden stop of the forklift 100, the server 300 specifies the range of the image area of the forklift 100 within the predetermined period including the time of occurrence of the rapid deceleration or sudden stop and generates training data. Furthermore, the server 300 compares a currently captured image with an image corresponding to the image data in the training data within the predetermined period including the time of occurrence of the rapid deceleration or sudden stop. If determining that these images are identical or similar to each other, the server 300 executes the predetermined notification process. This configuration can achieve notification based on the specialized training data for occurrence of an abnormal event, that is, a rapid deceleration or sudden stop of the forklift 100.

The above description of the embodiments and the drawings should not be construed as limiting the disclosure and may be modified as appropriate.

In the above-described embodiments, the range of the image area of the forklift 100 is specified such that the size of the image area of the forklift 100 increases with the size of the image area of the marker 102, as illustrated in FIGS. 5A and 5B. The range of the image area of the forklift 100, however, may also be specified in other manners.

For example, in the case where a forklift 100 includes multiple markers 102 installed at predetermined intervals, the range of the image area of the forklift 100 may expand according to an increase in the interval between the markers 102 in the image, which implies a decrease in the distance of the forklift 100 to the camera 200.

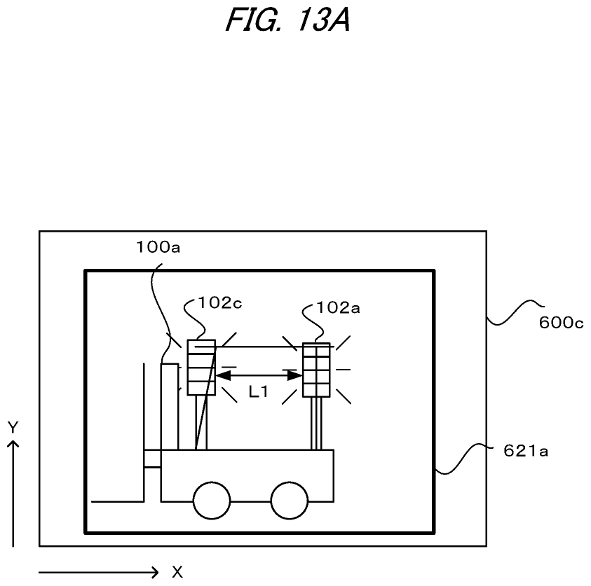

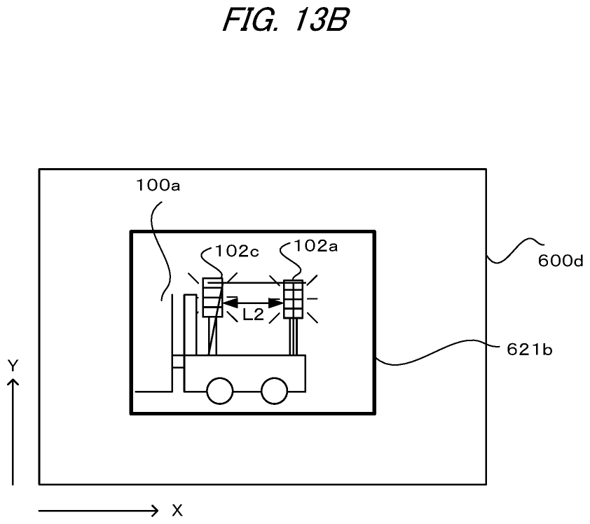

The following description assumes an example in which the forklift 100 is equipped with two markers 102a and 102c installed at an interval L (not shown), as illustrated in FIGS. 13A and 13B. In a captured image 600c illustrated in FIG. 13A, an image area 621a of the forklift 100 is defined on the basis of an interval L1 between the markers 102a and 102c in the image. In contrast, in a captured image 600d illustrated in FIG. 13B, an image area 621b of the forklift 100 is defined to be smaller than the image area 621a, on the basis of an interval L2 between the markers 102a and 102c in the image shorter than the interval L1 illustrated in FIG. 13A. That is, if the captured image comprises a plurality of first image areas, the processor (control unit 302) determines the second image area on basis of an interval between the first image areas.

Alternatively, in view of the fact that the camera 200 is installed at a high position and captures an image in the downward direction in general, the range of the image area of the forklift 100 may expand according to a downward shift of the position of the marker 102 in the image, which implies a decrease in the distance of the forklift 100 to the camera 200, for example.

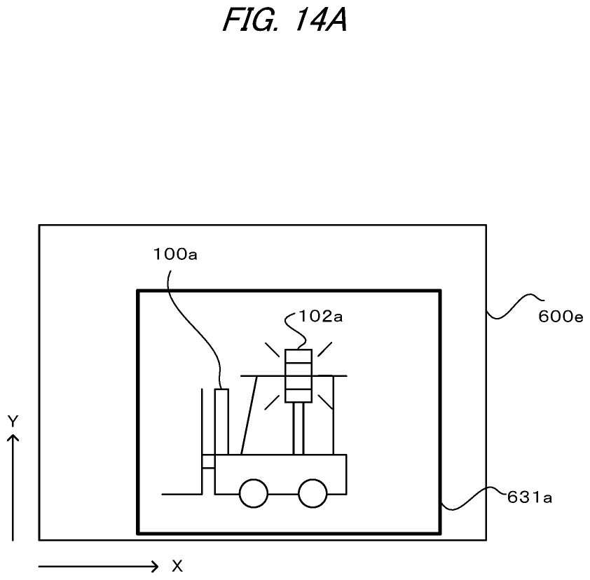

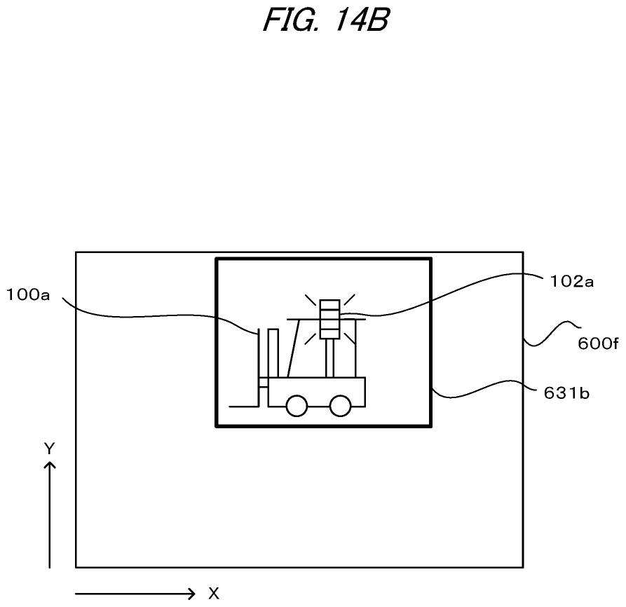

In a captured image 600e illustrated in FIG. 14A, an image area 631a of the forklift 100 is defined on the basis of the position of the marker 102a in the image, for example. In contrast, in a captured image 600f illustrated in FIG. 14B, an image area 631b of the forklift 100 smaller than the image area 631a is defined on the basis of the position of the marker 102a in the image higher than the position of the marker 102a in the image illustrated in FIG. 14A. That is, the processor (control unit 302) determines the second image area on basis of a position of the first image area in the captured image.

Although the classification ID indicates that the object is classified as a forklift in the above-described embodiments, this configuration is a mere example. The classification ID may contain information on the manufacturer, information on the existence of a load, or information for specifying the load. Also in this case, the processing and generation of training data are executed for each classification ID.

In addition, the captured-image data and the area data in the above-described embodiments may be associated with each other to configure training data.

Furthermore, in the case where a first rapid deceleration or sudden stop of the forklift 100 and generation of training data are followed by a second rapid deceleration or sudden stop of the forklift 100, the notification process is executed if the second situation is identical or similar to the training data, in the above-described embodiment. This configuration is, however, a mere example. The training data to be generated may be a variation in the three-dimensional position of the forklift, which represents a behavior of the forklift usually unexpected at the position, such as a sudden start, rapid acceleration, or rapid turning. In this case, the notification process may be executed if an image of the forklift 100 captured later is identical or similar to the training data, which implies an abnormal event.

The communication uses visible light, such as red, green, and blue light, in the above-described embodiments, but may also use visible light of other colors. The disclosure can also be applied to visible light communication in which information is modulated by means of only a time variation in luminance.

The component that provides identification information for specifying the range of the image area of the forklift 100 should not necessarily be the marker 102. For example, a part of the LCD, PDP, or EL display constituting the display may serve as a light source. Alternatively, the marker 102 may be replaced with an object (for example, paper medium, seal, or plate) for specifying the range of the image area of the forklift 100 using color, shape, or geometric pattern, such as barcode. This object may be installed at a position (for example, top or lateral position) on the forklift 100 that can be viewed and imaged from the cameras 200.

The server 300 may be equipped with the camera 200 therein.

In the above-described embodiments, the program to be executed may be stored for distribution in a non-transitory computer-readable recording medium, such as hard disk, flexible disk, compact disc read only memory (CD-ROM), digital versatile disc (DVD), or magneto-optical (MO) disc, which is removable and portable. In this case, the program is installed into a computer to configure a system executing the above-explained processes.

Alternatively, the program may be stored in a disk drive included in a certain server on a network, such as the Internet, and may be downloaded into a computer in the form of carrier waves, for example.

If the above functions are shared by an operating system (OS) or achieved by cooperation between the OS and application, only the data other than the OS may be stored in a medium for distribution or downloaded into a computer, for example.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

What is claimed is:

1. A method of generating training data executed by a computer, the method comprising:
determining a second image area in at least one captured image, the second image area comprising a first image area for acquiring identification information on a moving body; and
generating training data for machine learning, the training data corresponding to the determined second image area.

2. The method of generating training data according to claim 1, wherein the second image area has a size determined on basis of a size of the first image area.

3. The method of generating training data according to claim 1, wherein if the captured image comprises a plurality of first image areas, the second image area is determined on basis of an interval between the first image areas.

4. The method of generating training data according to claim 1, wherein the second image area is determined on basis of a position of the first image area in the captured image.

5. The method of generating training data according to claim 1, wherein
the at least one captured image comprises a plurality of images captured sequentially in time,
the method further comprises detecting a movement of the first image area in the images, and
the second image area is determined on basis of the movement of the first image area.

6. The method of generating training data according to claim 1, further comprising:
changing a color in the first image area, wherein
the training data is generated so as to correspond to the second image area comprising the first image area in which the color is changed.

7. The method of generating training data according to claim 1, further comprising:
detecting a rapid deceleration or sudden stop of the moving body, wherein
the training data is generated on basis of a captured image of the moving body corresponding to a time of occurrence of the rapid deceleration or sudden stop.

8. A training data generating apparatus comprising:
at least one processor, wherein the at least one processor executes the following:
determining a second image area in at least one captured image, the second image area comprising a first image area for acquiring identification information on a moving body; and
generating training data for machine learning, the training data corresponding to the determined second image area.

9. The training data generating apparatus according to claim 8, wherein the second image area has a size determined on basis of a size of the first image area.

10. The training data generating apparatus according to claim 8, wherein if the captured image comprises a plurality of first image areas, the second image area is determined on basis of an interval between the first image areas.

11. The training data generating apparatus according to claim 8, wherein the second image area is determined on basis of a position of the first image area in the captured image.

12. The training data generating apparatus according to claim 8, wherein
the at least one captured image comprises a plurality of images captured sequentially in time,
the at least one processor detects a movement of the first image area in the images, and
the second image area is determined on basis of the movement of the first image area.

13. The training data generating apparatus according to claim 8, wherein
the at least one processor changes a color in the first image area, and
the training data is generated so as to correspond to the second image area comprising the first image area in which the color is changed.

14. The training data generating apparatus according to claim 8, wherein
the at least one processor detects a rapid deceleration or sudden stop of the moving body, and
the training data is generated on basis of a captured image of the moving body corresponding to a time of occurrence of the rapid deceleration or sudden stop.

15. An image processing apparatus comprising:
at least one processor, wherein the at least one processor executes the following:
acquiring identification information on a moving body on basis of a captured image;
determining whether a movement of the moving body is a predetermined behavior on basis of the captured image and training data, the training data being generated on basis of a captured image corresponding to a past time of occurrence of a rapid deceleration or sudden stop of the moving body; and
providing a notification to the moving body if the movement is determined to be the predetermined behavior.
